(19) United States
(12) Patent Application Publication
(10) Pub. No.: US 2026/0217738 A1
(43) Pub. Date: Jul. 30, 2026

(54) One-Pot Process of Preparing the Borate Thiol Crosslinker and Polyolefin Vitrimer Prepared with the Same

(71) Applicant: ExxonMobil Technology and Engineering Company, Spring, TX (US)

(72) Inventors: Carlos R. LOPEZ-BARRON, Houston, TX (US); Jiemin LU, Manvel, TX (US)

(21) Appl. No.: 19/144,677

(22) PCT Filed: Dec. 19, 2023
(86) PCT No.: PCT/US2023/084745

§ 371 Date: Jun. 30, 2025

Related U.S. Application Data
(60) Provisional application No. 63/478,263, filed on Jan. 3, 2023.

(51) Int. Cl. C07F 5/02; C08F 8/42; C08J 3/24

(52) U.S. Cl. CPC C07F 5/025; C08F 8/42; C08J 3/24; C08F 2810/20; C08J 2323/16

(57) ABSTRACT

This disclosure relates generally to a one-pot process of preparing the borate (boron-ester) thiol crosslinker (1), to the borate thiol crosslinker (1), to a process of preparing a polyolefin vitrimer, to a polyolefin vitrimer prepared with the borate thiol crosslinker (1), to a composition comprising the polyolefin vitrimer and to an article comprising the polyolefin vitrimers.

### CROSS-REFERENCE TO RELATED APPLICATION

The present application claims priority to and the benefit of U.S. Provisional Application No. 63/478,263 filed on 3 Jan. 2023, which is hereby incorporated by reference in its entirety.

### FIELD OF THE INVENTION

This disclosure relates generally to a one-pot process of preparing the borate (boron-ester) thiol crosslinker (1), to the borate thiol crosslinker (1), to a process of preparing a polyolefin vitrimer, to a polyolefin vitrimer prepared with the borate thiol crosslinker (1), to a composition comprising the polyolefin vitrimer and to an article comprising the polyolefin vitrimers.

### BACKGROUND OF THE INVENTION

Vitrimers are a new class of polymeric materials displaying dynamically crosslinked networks. The topology of such networks is not fixed, as the bonds connecting the different polymer chains undergo associative exchange reactions that allows them to “dissociate” from a given location and “re-associate” in a different location in the network. These exchange reactions are activated at temperatures above the topological freezing transition temperature (Tv). Below Tv, vitrimers behave as solid elastic networks (i.e., as thermosets or vulcanized elastomers), and above Tv, they behave as viscoelastic liquids (i.e., as melts).

Yang et al. [Yang et al. (2020) Polym. Chem. , v.11, pg. 3285] report the synthesis of a terpolymer or ethylene, 1-tetradecane and 9-(but-3-en-1-yl) anthracene. Two subsequent steps, namely Diels-Alder reaction with dioxaborolane maleimide, and mixing with bis-dioxaborolane, produced the POE vitrimers. A different approach reported by Wang et al. (2021) J. Polym. Res., v.28:210 consists of grafting 1-[(2-phenyl-1,3,2-dioxaborolane-4-yl)methyl]-1H-pyrrole-2,5-dione onto commercial ethylene-octene copolymers used peroxide in an internal mixer at 170° C., and subsequent addition of the cross-linker 2,2′-(1,4-Phenylene)-bis [4-methyl-1,3,2-dioxaborolane].

This disclosure discloses a different approach comprising the synthesis of borate thiol crosslinker (1) in a one-pot process. This borate thiol crosslinker (1) can be directly grafted onto the polyolefins containing double bonds to form vitrimers in one step using thermal or UV initiators.

### SUMMARY OF THE INVENTION

In a first general aspect, this disclosure provides a one-pot process of preparing compound (1), wherein compound (1) contains at least two reversible borate moieties or derivative thereof and at least two mercapto groups (—SH), wherein the derivative of borate moiety represents a moiety with the oxygen in the borate moiety being replaced with other element of the sixth main group, for example sulfur, and there is a reversible borate moiety or derivative thereof between any two mercapto groups; wherein the process comprises reacting a B-containing compound (3) with a polyol-type compound (4) to obtain a reaction mixture (2), and reacting the reaction mixture (2) with a compound (5) containing a carboxyl and a mercapto group (—SH) to form compound (1), wherein the B-containing compound (3) is selected from a compound having a structure of B(QR)₃ and a compound having at least two B(QR)₂ groups, wherein R is selected from H or C₁-C₆-alkyl and each Q is independently an element of the sixth main group, or oxygen or sulfur; and wherein the polyol-type compound (4) has three hydroxyls and two of them are capable of forming the reversible borate moiety or derivative thereof with the B-containing compound (3), or the polyol-type compound (4) has one hydroxyl and one ethylene oxide ring or oxetane ring.

In a second general aspect, this disclosure provides compound (1) containing at least two reversible borate moieties or derivative thereof and at least two mercapto groups (—SH) obtainable by the one-pot process of this disclosure.

In a third general aspect, this disclosure provides a process of preparing a polyolefin vitrimer comprising:
(i) preparing compound (1) containing at least two reversible borate moieties or derivative thereof and at least two mercapto groups (—SH) via the one-pot process of this disclosure; and
(ii) reacting the polyolefin containing double bonds with compound (1) to obtain the polyolefin vitrimer.

In a fourth general aspect, this disclosure provides a polyolefin vitrimer prepared with the polyolefin containing double bonds and the compound (1) of this disclosure.

In a fifth general aspect, this disclosure provides a composition comprising the polyolefin vitrimer of this disclosure and at least one additive.

In a sixth general aspect, this disclosure provides an article comprising the polyolefin vitrimers of this disclosure or the composition of this disclosure.

Certain aspects of the first, second, third, fourth, fifth and sixth general aspects may include one or more of the following features.

In some aspects, the solvent S1 produced is removed during the reaction of the B-containing compound (3) with the polyol-type compound (4), and/or the solvent S2 produced is removed during the reaction of the reaction mixture (2) with compound (5), preferably the solvent S1 and/or solvent S2 is removed by a trapping agent or by using a Dean-Stark apparatus or by distillation.

In some aspects, the reaction of the B-containing compound (3) with the polyol-type compound (4), and/or reaction of the reaction mixture (2) with compound (5) are carried out in the presence of a sulfonic acid.

In some aspects, the polyol-type compound (4) and compound (5) are used in stoichiometric amount to in an excess of 15% of the stoichiometric amount, or in an excess of 2% of the stoichiometric amount to in an excess of 10% of the stoichiometric amount, based on the B-containing compound (3).

In some aspects, the reaction of the B-containing compound (3) with the polyol-type compound (4), and the reaction of the reaction mixture (2) with compound (5) are carried out at a temperature of 105° C. to 180° C., or 110° C. to 155° C., preferably under reflux.

In some aspects, the reversible borate moiety or derivative thereof has a structure of Formula (I):

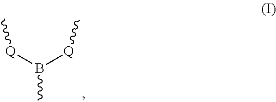

wherein each Q is independently an element of the sixth main group, or oxygen or sulfur.

In some aspects, the -Q-B-Q-moiety in Formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring (for example ring (A) as described below) to form a fused ring system; or two -Q-B-Q-moieties share one B atom and form a spiro ring.

In some aspects, the boron-containing ring has the following structure:

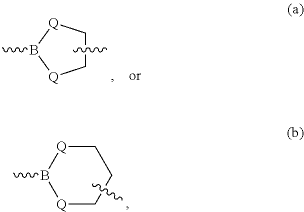

the fused ring system containing the boron-containing ring has the following structure:

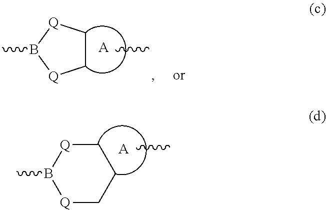

wherein A is a ring having 5 to 10 ring members and wherein each Q is independently an element of the sixth main group, or oxygen or sulfur; or two -Q-B-Q-moieties share one B atom and form a spiro ring.

In some aspects, the compound (1) is selected from a compound of Formulae (B), (D), (F) and (H)

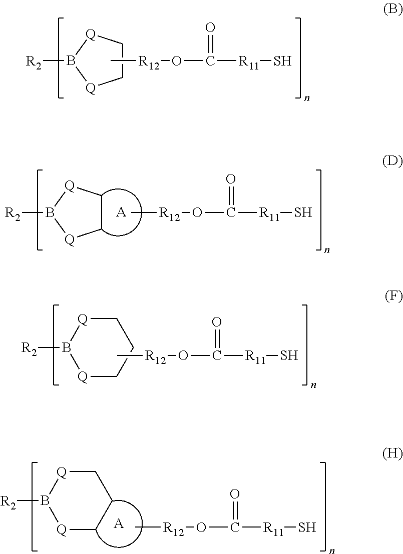

wherein:
each R₁₁ is independently a divalent organic group having 1 to 20 carbon atoms;
each R₁₂ is independently a divalent organic group having 1 to 20 carbon atoms;
each R₂ is independently a direct bond or an organic group having 1 to 20 carbon atoms;
   or two -Q-B-Q-moieties share one B atom and form a spiro ring;
each A is independently a ring having 5 to 10 ring members;
each Q is independently an element of the sixth main group, or oxygen or sulfur; and
n is 2, 3 or 4.

In some aspects, the variables in Formulae (B), (D), (F) and (H) have the following meanings:
each R₁₁ is independently a divalent organic group having 2 to 16 carbon atoms;
each R₁₂ is independently a divalent organic group having 2 to 16 carbon atoms;
each R₂ is independently a direct bond or an organic group having 1 to 18 carbon atoms;
each A is independently a ring having 5 or 6 ring members;
each Q is oxygen; and
n is 2 or 3.

In some aspects, the B-containing compound (3) is selected from a compound having a structure of B(QR)₃ and a compound of Formula (B3)

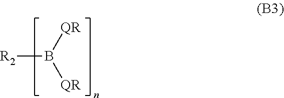

wherein R is selected from H or C₁-C₆-alkyl, for example C₁-C₄-alkyl or H;
each Q is independently an element of the sixth main group, or oxygen or sulfur, for example oxygen;
each R₂ is independently a direct bond or an organic group having 1 to 20 or 1 to 18 carbon atoms; and
n is 2, 3 or 4, for example 2 or 3.

In some aspects, the polyol-type compound (4) is selected from a compound of Formulae (B4), (B4′), (D4), (D4′), (F4), (F4′), (H4) and (H4′):

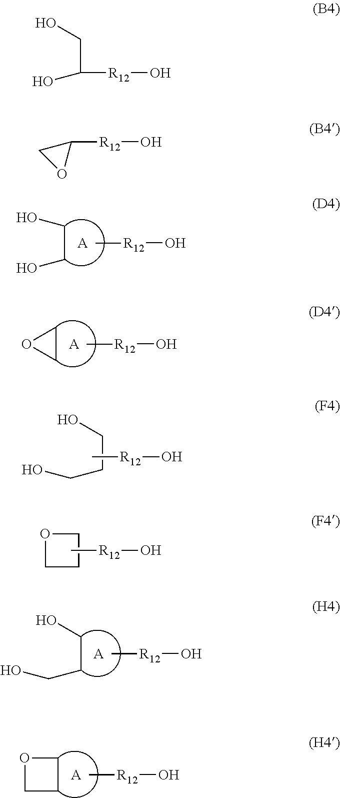

wherein:
each A is independently a ring having 5 to 10, for example 5 or 6 ring members; and
each R₁₂ is independently a divalent organic group having 1 to 20 or 2 to 16 carbon atoms.

In some aspects, the compound (5) containing a carboxyl and a mercapto group (—SH) is compound of Formula (B5)

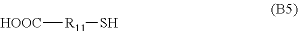

wherein R₁₁ is a divalent organic group having 1 to 20 or 2 to 16 carbon atoms.

In some aspects, the compound (1) is a compound of Formula (B)

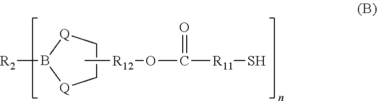

wherein R₂, Q, R₁₁, R₁₂ and n are as defined above, or two -Q-B-Q-moieties share one B atom and form a spiro ring;
wherein the process comprises reacting a B-containing compound (3) selected from a compound having a structure of B (QR)₃ and a compound of Formula (B3)

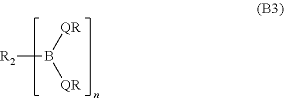

wherein R is selected from H or C₁-C₆-alkyl, for example H, and
R₂, Q and n are as defined above, with a polyol-type compound (4) selected from a compound of Formulae (B4) and (B4′),

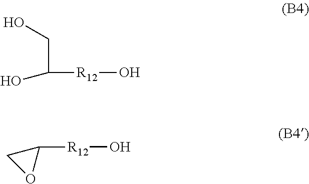

wherein R₁₂ is as defined above,
to obtain a reaction mixture (2), and
reacting the reaction mixture (2) with a compound (5) selected from a compound of Formula (B5)

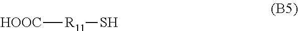

wherein R₁₁ is as defined above,
to obtain a compound of Formula (B).

In some aspects, the compound (1) is a compound of Formula (D)

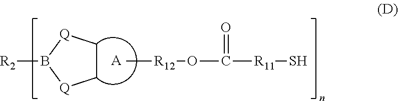

wherein R₂, Q, A, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

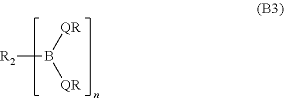

wherein R is selected from H or C₁-C₆-alkyl, for example H, and R₂, Q and n are as defined above,
with a polyol-type compound (4) selected from a compound of Formulae (D4)

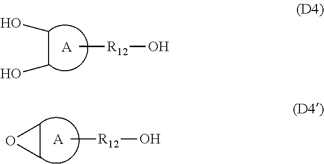

wherein A and R₁₂ are as defined above,
to obtain a reaction mixture (2), and
reacting the reaction mixture (2) with a compound (5) selected from a compound of Formula (B5)

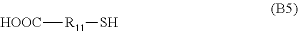

wherein R₁₁ is as defined above,
to obtain a compound of Formula (D).

In some aspects, the compound (1) is a compound of Formula (F)

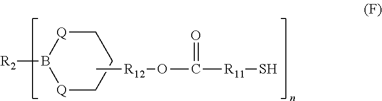

wherein R₂, Q, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

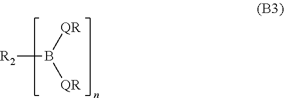

wherein R is selected from H or C₁-C₆-alkyl, for example H, and
R₂, Q and n are as defined above,
with a polyol-type compound (4) selected from a compound of Formulae (F4)

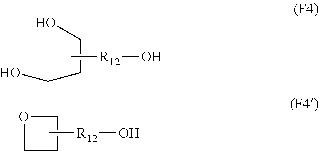

wherein R₁₂ is as defined above,
to obtain a reaction mixture (2), and
reacting the reaction mixture (2) with a compound (5) selected from a compound of Formula (B5)

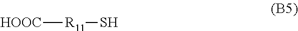

wherein R₁₁ is as defined above,
   to obtain a compound of formula (F).

In some aspects, the compound (1) is a compound of Formula (H)

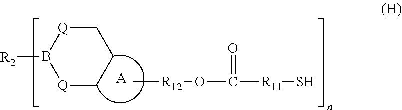

wherein R₂, Q, A, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

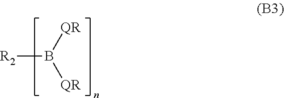

wherein R is selected from H or C₁-C₆-alkyl, for example H, and
R₂, Q and n are as defined above,
with a polyol-type compound (4) selected from a compound of Formulae (H4) and (H4′)

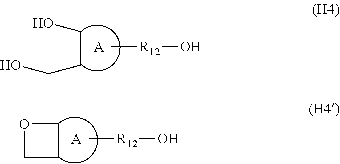

wherein A and R₁₂ are as defined above,
to obtain a reaction mixture (2), and
reacting the reaction mixture (2) with a compound (5) selected from a compound of

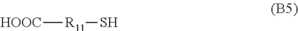

wherein R₁₁ is as defined above,
to obtain a compound of Formula (H).

In some aspects, the variables have following definitions:
each R₁₁ is independently a divalent hydrocarbyl having 1 to 20 or 2 to 16 carbon atoms;
each R₁₂ is independently a divalent hydrocarbyl having 1 to 20 or 2 to 16 carbon atoms;
each R₂ is independently a direct bond or a hydrocarbyl having 1 to 20 or 1 to 18 carbon atoms; or two -Q-B-Q-moieties share one B atom and form a spiro ring;
wherein the above hydrocarbyl can optionally be interrupted by one or more non adjacent oxygen atoms, and/or one or more non adjacent carbon atoms in the hydrocarbyl can optionally be replaced with —(CO)—O— and/or CO.

In some aspects, compound (1) is (1,4-phenylenebis(1,3,2-dioxaborolane-2,4-diyl))bis(butane-4,1-diyl) bis(11-mercaptoundecanoate).

In the third aspect, the amount of compound (1) is in the range from 1 to 25 wt %, or from 1.2 to 20 wt %, or from 1.5 to 15 wt %, based on the weight of the polyolefin containing double bonds.

In the fourth aspect, the polyolefin vitrimer meets at least one of following requirements:
(r-1) the tensile stress at 400% strain of the polyolefin vitrimer is at least 350%, or at least 450% of the tensile stress at 400% strain of the neat polyolefin;
(r-2) the storage modulus of the polyolefin vitrimer tested by dynamic frequency sweeps at 50° C. and at a frequency of 6.283×10⁻⁴ rad/s is at least 1, or at least 1.5 orders of magnitude larger than that of the neat polyolefin;
(r-3) the complex viscosity of the polyolefin vitrimer tested by dynamic frequency sweeps at 50° C. and at a frequency of 6.283×10⁻⁴ rad/s is at least 0.5, or at least 1 order of magnitude larger than that of the neat polyolefin;
(r-4) the polyolefin vitrimer displays extensional strain hardening.

The process of this disclosure enables the borate thiol crosslinker, i.e., compound (1) to be prepared in a one-pot process in high yield. Compound (1) can be directly grafted onto the polyolefins containing double bonds to form vitrimers in one step using thermal or UV initiators. The polyolefin vitrimer shows enhanced properties including high tensile stress, high storage modulus and also shows superior processability properties (high melt strength, shear thinning and extensional strain hardening).

These and other features and attributes of the disclosed vitrimer of the present disclosure and their advantageous applications and/or uses will be apparent from the detailed description which follows.

### DESCRIPTION OF THE DRAWING

FIG. 1 shows dynamic mechanical temperature runs of EPDM and the vitrimers listed in Table 1. Temperature ramps were performed at a heating rate of 2° C./min.

FIG. 2 shows dynamic frequency sweeps of the neat EPDM and the vitrimer samples.

FIG. 3 shows extensional rheology at 50° C. of neat EPDM and the vitrimers.

FIG. 4 shows stress-strain curves of EPDM, EPDM-AIBN and EPDM vitrimers measured at room temperature. (a) Measurements with stretching the samples until break. (b) Hysteresis (loading-unloading cycles) of EPDM-V3 sample.

### DETAILED DESCRIPTION OF THE INVENTION

Various specific embodiments, versions, and examples are described herein; including exemplary embodiments and definitions that are adopted for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

All numerical values within the detailed description and the claims herein are modified by “about” the indicated value, and take into account experimental error and variations that would be expected by those skilled in the art.

### One-Pot Process of Preparing Compound (1)

In a first general aspect, this disclosure provides a one-pot process of preparing compound (1), wherein compound (1) contains at least two reversible borate moieties or derivative thereof and at least two mercapto groups (—SH), wherein the derivative of borate moiety represents a moiety with the oxygen in the borate moiety being replaced with other element of the sixth main group, for example sulfur, and there is a reversible borate moiety or derivative thereof between any two mercapto groups;
wherein the process comprises reacting a B-containing compound (3) with a polyol-type compound (4) to obtain a reaction mixture (2), and reacting the reaction mixture (2) with a compound (5) containing a carboxyl and a mercapto group (—SH) to form compound (1),
wherein the B-containing compound (3) is selected from a compound having a structure of B(QR)₃ and a compound having at least two B(QR)₂ groups, wherein R is selected from H or C₁-C₆-alkyl and each Q is independently an element of the sixth main group, or oxygen or sulfur; and
wherein the polyol-type compound (4) has three hydroxyls and two of them are capable of forming the reversible borate moiety or derivative thereof with the B-containing compound (3), or the polyol-type compound (4) has one hydroxyl and one ethylene oxide ring or oxetane ring.

In the present disclosure, the element of the sixth main group is preferably O or S, more preferably O. The “other element of the sixth main group” can be S.

According to this disclosure, the phrase “the oxygen in the borate moiety being replaced with other element of the sixth main group” means the oxygen in the borate moiety is replaced with an element of the sixth main group, which is different from oxygen, for example the oxygen in the borate moiety can be replaced with S.

In an embodiment, the derivative of borate moiety represents a moiety with the oxygen in the borate moiety being replaced with S.

According to this disclosure, there is no substituent on Q.

In an embodiment, two borate moieties can share one B atom and form a spiro ring.

In an embodiment, the reversible borate moiety or derivative thereof has a structure of Formula (I):

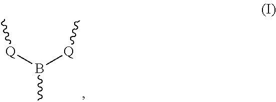

wherein each Q is independently an element of the sixth main group, preferably O or S, more preferably O.

In an embodiment, the -Q-B-Q-moiety in Formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring (for example ring A as described below) to form a fused ring system, or two -Q-B-Q-moieties share one B atom and form a spiro ring.

In an embodiment, the boron-containing ring has the following structure:

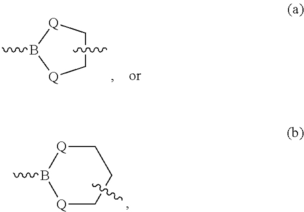

the fused ring system containing the boron-containing ring has the following structure:

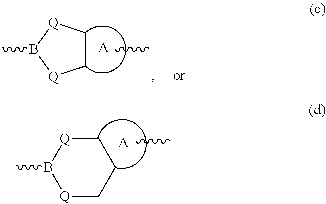

wherein A is a ring having 5 to 10 ring members and wherein each Q is independently an element of the sixth main group, preferably oxygen or sulfur;
or two -Q-B-Q-moieties share one B atom and form a spiro ring.

According to this disclosure, the ring (A) fused with the boron-containing ring is a ring having 5 to 10 ring members, such as 5 to 8, or 5, 6, or 7 ring members. The ring (A) can be saturated, or partially unsaturated or aromatic carbo- or heterocyclic ring, which contains 1 to 4 (1, 2, 3, or 4), or 1 to 3 heteroatoms selected from N, O, and S, and wherein the aforementioned carbo- or heterocyclic rings system can be unsubstituted or substituted, wherein the substituents on the ring can join to form additional rings.

Examples of the heterocyclic rings as ring (A) include one of following:

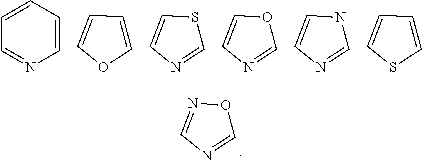

Examples of aromatic ring as ring (A) comprise phenyl ring or naphthalene ring.

In an embodiment, the fused ring system containing the boron-containing ring has the following structure:

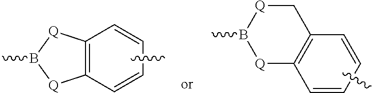

wherein each Q is independently an element of the sixth main group, preferably oxygen or sulfur.

In an embodiment, compound (1) contains 2 to 3 (for example 2 or 3) reversible borate moieties or derivative thereof and 2 to 4 (for example 2, 3 or 4)-SH groups. In an embodiment, compound (1) contains 2 to 3 (for example 2 or 3) reversible borate moieties or derivative thereof and 2-SH groups. In an embodiment, compound (1) contains 2 to 3 (for example 2 or 3) reversible borate moieties or derivative thereof and 3-SH groups. In an embodiment, compound (1) contains 2 reversible borate moieties or derivative thereof and 2 or 3-SH groups. In an embodiment, compound (1) contains 2 reversible borate moieties or derivative thereof and 2-SH groups. In an embodiment, compound (1) contains 2 reversible borate moieties and 2-SH groups.

In an embodiment, the reversible borate moieties or derivative thereof and the —SH group is connected with a link group, which is organic group, preferably divalent hydrocarbyl (for example alkylene) contains 1 to 40 carbon atoms (for example 2, 3, 4, 5, 6, 8, 10, 12, 16, 18, 20, 25, 30, 35, or 40 carbon atoms), or 2 to 40, or 3 to 35, or 4 to 30, or 5 to 25, or 6 to 20 carbon atoms. The divalent hydrocarbyl (for example alkylene) can optionally be interrupted by one or more non adjacent oxygen atoms, and/or one or more non adjacent carbon atoms in the divalent hydrocarbyl (for example alkylene) can optionally be replaced with —(CO)—O— and/or CO.

In an embodiment, the compound (1) is selected from a compound of Formulae (B), (D), (F) and (H)

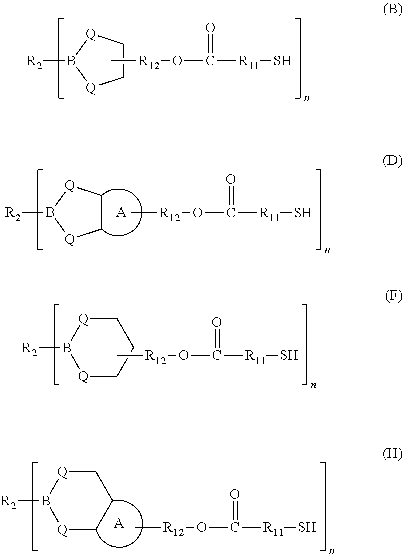

wherein:
each R₁₁ is independently a divalent organic group having 1 to 20 carbon atoms;
each R₁₂ is independently a divalent organic group having 1 to 20 carbon atoms;
each R₂ is independently a direct bond or an organic group having 1 to 20 carbon atoms or two -Q-B-Q-moieties share one B atom and form a spiro ring;
each A is independently a ring having 5 to 10 ring members;
each Q is independently an element of the sixth main group, or oxygen or sulfur; and
n is 2, 3 or 4.

In an embodiment, the variables in Formulae (B), (D), (F) and (H) have the following meanings:
each R₁₁ is independently a divalent organic group having 2 to 18 carbon atoms;
each R₁₂ is independently a divalent organic group having 2 to 16 carbon atoms;
each R₂ is independently a direct bond or an organic group having 1 to 18 carbon atoms or two -Q-B-Q-moieties share one B atom and form a spiro ring;
each A is independently a ring having 5 or 6 ring members;
each Q is oxygen; and
n is 2 or 3.

In an embodiment, each R₁₁ is independently a divalent hydrocarbyl (for example alkylene) having 1 to 18 carbon atoms (for example 2, 4, 6, 8, 10, 12, 15, 16 or 18 carbon atoms), or 2 to 18 or 4 to 18 or 6 to 16 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO.

In an embodiment, each R₁₂ is independently a divalent hydrocarbyl (for example alkylene) having 1 to 18 carbon atoms (for example 2, 4, 6, 8, 10, 12, 15, 16 or 18 carbon atoms), or 1 to 16 or 1 to 12 or 1 to 6 or 1 to 4 or 2 to 12, or 2 to 6, or 3 to 12, or 3 to 6 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO.

In an embodiment, each R₂ is independently a direct bond or a hydrocarbyl having 1 to 20 carbon atoms (for example 1, 2, 3, 4, 5, 6, 7, 8, 9, 10, 11, 12, 13, 14, 15, 16, 17, 18, 19 or 20, or 1 to 20, 1 to 18, 1 to 16, 1 to 10, 1 to 12, 1 to 6, 2 to 20, 2 to 16, 2 to 12, 2 to 10, 2 to 6, 3 to 20, 3 to 16, 3 to 10, 3 to 12, 3 to 6, 4 to 20, 4 to 16, 4 to 10, 4 to 12, 4 to 6, 5 to 20, 5 to 16, 5 to 10, 5 to 12, 5 to 6, 6 to 20, 6 to 16, 6 to 10 carbon atoms), which can optionally be interrupted by one or more non adjacent oxygen atoms, and/or one or more non adjacent carbon atoms in the hydrocarbyl can optionally be replaced with —(CO)—O— and/or CO; and a 5-20-membered (for example 5, 6, 7, 8, 9, 10, 11, 12, 13, 14, 15, 16, 17, 18, 19, or 20, 5-18, 5-16, 5-12, or 5-10-membered) heterocyclic ring which contains 1 to 3 (for example 1, 2 or 3) heteroatoms selected from N, O, and S; or two -Q-B-Q-moieties share one B atom and form a spiro ring.

If two -Q-B-Q-moieties share one B atom and form a spiro ring, R₂ does not exist and n is 2.

A person skilled in the art could understand that, the valence of R₂ corresponds to the value of n, for example if n is 2, valence of R₂ is 2; if n is 3, valence of R₂ is 3; if n is 4, valence of R₂ is 4.

The terms “hydrocarbyl radical,” “hydrocarbyl” and “hydrocarbyl group” are used interchangeably throughout this document unless otherwise specified. For purposes of this disclosure, a hydrocarbyl radical is defined to be C₁ to C₂₀ radicals (for example, C₁, C₂, C₃, C₄, C₅, C₆, C₈, C₁₀, C₁₂, C₁₆, C₁₈, or C₂₀) or C₁ to C₁₂ radicals, C₁ to C₆ radicals, C₂ to C₁₂ radicals, C₃ to C₁₂ radicals, or C₄ to C₁₂ radicals, or C₅ to C₂₀ radicals, C₆ to C₂₀ radicals, or C₇ to C₂₀ radicals or C₅ to C₁₀ radicals, or C₅ to C₁₀ radicals or C₆ to C₁₀ radicals that may be linear, branched, or cyclic where appropriate (aromatic or non-aromatic, such as saturated or unsaturated); and can further include hydrocarbyl radicals substituted with other hydrocarbyl radicals and/or one or more functional groups.

In an embodiment, each R₂ is independently a direct bond, a liner or branched C₁-C₂₀ hydrocarbyl, which can optionally be interrupted by one or more non adjacent oxygen atoms, and/or one or more non adjacent carbon atoms in the hydrocarbyl can optionally be replaced with —(CO)—O— and/or CO; a saturated, or partially unsaturated or aromatic carbo- or heterocyclic ring having 3 to 20 carbon atoms, which contains 1 to 3 (for example 1, 2, 3) heteroatoms selected from N, O, and S; or two -Q-B-Q-moieties share one B atom and form a spiro ring. The number of carbon atoms of the liner or branched hydrocarbyl and the number of carbon atoms of ring are as mentioned above for the organic groups.

In an embodiment, each R₂ is independently a direct bond or a liner or branched hydrocarbyl having 1 to 12 carbon atoms (for example 1 to 6 carbon atoms, or 1 to 4 carbon atoms, or 2 to 12, or 4 to 12, or 2 to 6, or 4 to 6, or 6 to 10 carbon atoms); C₄-C₈-cycloalkyl, C₅-C₁₀-cycloalkenyl, C₆-C₁₀ aryl, C₁-C₁₂ alkyl-C₆-C₁₀ aryl, C₆-C₁₀ aryl-C₆-C₁₀ aryl, C₆-C₁₀ aryl-C₁-C₁₂ alkylene-C₆-C₁₀ aryl, C₄-C₁₀ heterocycloalkyl, C₄-C₁₀ heterocycloalkenyl, C₄-C₁₀ hetaryl, C₄-C₁₀ hetaryl-C₄-C₁₀ hetaryl, wherein the hydrocarbyl and the C₁-C₁₂ alkylene can optionally be interrupted by one or more non adjacent oxygen atoms, and/or one or more non adjacent carbon atoms in the hydrocarbyl and the C₁-C₁₂ alkylene can optionally be replaced with —(CO)—O— and/or CO and wherein the heterocycloalkyl, heterocycloalkenyl and hetaryl contain 1 to 3 (for example 1, 2, 3) heteroatoms selected from N, O, and S; and wherein the valence of R₂ corresponds to the value of n.

In an embodiment, each R₂ is independently a direct bond, divalent or trivalent C₁-C₁₂ alkyl, divalent or trivalent C₄-C₈-cycloalkyl, divalent or trivalent C₅-C₁₀-cycloalkenyl, divalent or trivalent C₆-C₁₀ aryl, divalent or trivalent C₁-C₁₂ alkyl-C₆-C₁₀ aryl, divalent or trivalent C₆-C₁₀ aryl-C₆-C₁₀ aryl, divalent or trivalent C₆-C₁₀ aryl-C₁-C₁₂ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₁-C₁₂ alkyl and the C₁-C₁₂ alkylene can optionally be interrupted by one or more non adjacent oxygen atoms, and/or one or more non adjacent carbon atoms in the divalent or trivalent C₁-C₁₂ alkyl and the C₁-C₁₂ alkylene can optionally be replaced with —(CO)—O— and/or CO.

Taking divalent or trivalent C₁-C₁₂ alkyl-C₆-C₁₀ aryl as an example, it means the total valence of C₁-C₁₂ alkyl-C₆-C₁₀ aryl is divalence or trivalence.

In an embodiment, each R₂ is independently a direct bond, divalent or trivalent C₁-C₆ alkyl, or divalent or trivalent C₄-C₈-cycloalkyl, divalent or trivalent C₅-C₁₀-cycloalkenyl, divalent or trivalent C₆-C₁₀ aryl, divalent or trivalent C₁-C₆ alkyl-C₆-C₁₀ aryl, divalent or trivalent C₆-C₁₀ aryl-C₆-C₁₀ aryl, divalent or trivalent C₆-C₁₀ aryl-C₁-C₆ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₁-C₆ alkyl and the C₁-C₆ alkylene can optionally be interrupted by one or more non adjacent oxygen atoms, and/or one or more non adjacent carbon atoms in the divalent or trivalent C₁-C₆ alkyl and the C₁-C₆ alkylene can optionally be replaced with —(CO)—O— and/or CO.

In an embodiment, each R₂ is independently a direct bond, divalent or trivalent C₄-C₁₂ alkyl, or divalent or trivalent C₄-C₈-cycloalkyl, divalent or trivalent C₅-C₁₀-cycloalkenyl, divalent or trivalent C₆-C₁₀ aryl, divalent or trivalent C₁-C₆ alkyl-C₆-C₁₀ aryl, divalent or trivalent C₆-C₁₀ aryl-C₆-C₁₀ aryl, divalent or trivalent C₆-C₁₀ aryl-C₁-C₆ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₄-C₁₂ alkyl and the C₁-C₆ alkylene can optionally be interrupted by one or more non adjacent oxygen atoms, and/or one or more non adjacent carbon atoms in the divalent or trivalent C₄-C₁₂ alkyl and the C₁-C₆ alkylene can optionally be replaced with —(CO)—O— and/or CO.

In an embodiment, each R₂ is independently a direct bond, C₁-C₁₂ alkylene (i.e., divalent C₁-C₁₂ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₁₂ alkylene-C₆-C₁₀ aryl, divalent C₄-C₁₀ heterocycloalkyl, divalent C₄-C₁₀ heterocycloalkenyl, divalent C₄-C₁₀ hetaryl, divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₁₂ alkylene can optionally be interrupted by one or more non adjacent oxygen atoms, and/or one or more non adjacent carbon atoms in the C₁-C₁₂ alkylene can optionally be replaced with —(CO)—O— and/or CO.

In an embodiment, each R₂ is independently a direct bond, C₄-C₁₂ alkylene (i.e., divalent C₄-C₁₂ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₁₂ alkylene-C₆-C₁₀ aryl, divalent C₄-C₁₀ heterocycloalkyl, divalent C₄-C₁₀ heterocycloalkenyl, divalent C₄-C₁₀ hetaryl, divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₄-C₁₂ alkylene and the C₁-C₁₂ alkylene can optionally be interrupted by one or more non adjacent oxygen atoms, and/or one or more non adjacent carbon atoms in the C₄-C₁₂ alkylene and the C₁-C₁₂ alkylene can optionally be replaced with —(CO)—O— and/or CO.

In an embodiment, each R₂ is independently a direct bond, C₁-C₆ alkylene (i.e., divalent C₁-C₆ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₆ alkylene can optionally be interrupted by one or more non adjacent oxygen atoms, and/or one or more non adjacent carbon atoms in the C₁-C₆ alkylene can optionally be replaced with —(CO)—O— and/or CO.

In an embodiment, each R₂ is independently a divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₆ alkylene can optionally be interrupted by one or more non adjacent oxygen atoms, and/or one or more non adjacent carbon atoms in the C₁-C₆ alkylene can optionally be replaced with —(CO)—O— and/or CO; preferably divalent C₆-C₁₀ aryl, divalent C₆-C₁₀ aryl-C₆-C₁₀ aryl, divalent C₄-C₁₀ hetaryl or divalent C₄-C₁₀ hetaryl-C₄-C₁₀ hetaryl, wherein the hetaryl contains 1 to 3 (for example 1, 2, 3) heteroatoms selected from N, O, and S.

In an embodiment, each R₂ is independently a phenylene, phenylene-phenylene, or divalent thiophene radical.

A is as defined above, for example, each A is independently a ring having 5 or 6 ring members.

In an embodiment, n is 2 or 3, for example 2, for example 3.

In an embodiment, Q is S or O, preferably O.

In an embodiment, the variables in Formulae (B), (D), (F) and (H) have the following meanings:
each R₁₁ is independently a divalent hydrocarbyl (for example alkylene) having 1 to 18 carbon atoms (for example 2, 4, 6, 8, 10, 12, 15, 16 or 18 carbon atoms), or 2 to 18 or 4 to 18 or 6 to 16 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO;
each R₁₂ is independently a divalent hydrocarbyl (for example alkylene) having 1 to 18 carbon atoms (for example 2, 4, 6, 8, 10, 12, 15, 16 or 18 carbon atoms), or 1 to 16, or 1 to 12, or 1 to 6, or 1 to 4, or 2 to 12, or 2 to 6, or 3 to 12, or 3 to 6 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO;
each R₂ is independently a direct bond or divalent C₆-C₁₀ aryl, divalent C₆-C₁₀ aryl-C₆-C₁₀ aryl, divalent C₄-C₁₀ hetaryl or divalent C₄-C₁₀ hetaryl-C₄-C₁₀ hetaryl, wherein the hetaryl contains 1 to 3 (for example 1, 2, 3) heteroatoms selected from N, O, and S; or two -Q-B-Q-moieties share one B atom and form a spiro ring;
each A is independently a ring having 5 or 6 ring members;
each Q is oxygen; and
n is 2 or 3.

In an embodiment, the variables in Formulae (B), (D), (F) and (H) have the following meanings:
each R₁₁ is independently an alkylene having 1 to 18 carbon atoms (for example 2, 4, 6, 8, 10, 12, 15, 16 or 18 carbon atoms), or 2 to 18, or 4 to 18, or 6 to 16 carbon atoms, which can optionally be interrupted by one or more non adjacent oxygen atoms, and/or one or more non adjacent carbon atoms in the alkylene can optionally be replaced with —(CO)—O— and/or CO;
each R₁₂ is independently an alkylene having 1 to 18 carbon atoms (for example 2, 4, 6, 8, 10, 12, 15, 16 or 18 carbon atoms), or 1 to 16, or 1 to 12, or 1 to 6, or 1 to 4, or 2 to 12, or 2 to 6, or 3 to 12, or 3 to 6 carbon atoms, which can optionally be interrupted by one or more non adjacent oxygen atoms, and/or one or more non adjacent carbon atoms in the alkylene can optionally be replaced with —(CO)—O— and/or CO;
each R₂ is independently a phenylene, phenylene-phenylene, or divalent thiophene radical;
each A is independently a ring having 5 or 6 ring members;
each Q is oxygen; and
n is 2 or 3.

In this disclosure, the B-containing compound (3) can be selected from a compound having a structure of B(QR)₃ and a compound having at least two (for example 2, 3 or 4) B(QR)₂ groups, wherein R is selected from H or C₁-C₆-alkyl, for example methyl, ethyl, propyl or butyl and each Q is independently an element of the sixth main group, or oxygen or sulfur. In an embodiment, R is H. In an embodiment, R is C₁-C₆-alkyl, for example methyl, ethyl, propyl or butyl.

In an embodiment, R can be C₁-C₆-alkyl, for example methyl, ethyl or propyl, preferably methyl or ethyl in the structure of B(QR)₃. In an embodiment, R can be H in the structure of B(QR)₂.

The B-containing compound (3) can be selected from trimethyl borate, triethyl borate, tri-n-propyl borate, tri-isopropyl borate, tri-butyl borate, tri-tert-butyl borate, benzen-1,4-diboronic acid, 2,5-thiophenediboranic acid, 4,4-biphenyldiboronic acid, polyboric acid and tetrahydroxydiboron and ((((oxybis(ethane-2,1-diyl))bis(oxy))bis(methylene))bis(4,1-phenylene))diboronic acid.

In this disclosure, the polyol-type compound (4) has three hydroxyls and two of them are capable of forming the reversible borate moiety or derivative thereof with the B-containing compound, or the polyol-type compound has one hydroxyl and one ethylene oxide ring or oxetane ring. Said two hydroxyls capable of forming the reversible borate moiety or derivative thereof with the B-containing compound have the following structure: two carbon atoms carrying said two hydroxyls are in ortho position (for example 1,2-diol structure) or is interrupted by one carbon atom (for example 1,3-diol structure).

In an embodiment, the polyol-type compound (4) is selected from a compound of Formulae (B4), (B4′), (D4), (D4′), (F4), (F4′), (H4) and (H4′):

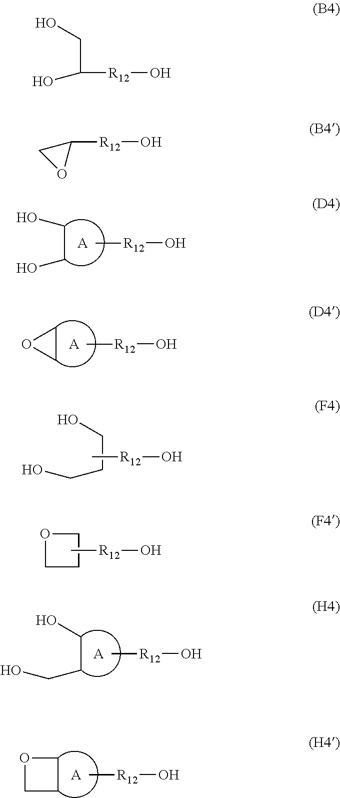

each A is independently a ring having 5 to 10, for example 5 or 6 ring members; and
each R₁₂ is independently a divalent organic group having 1 to 20 or 2 to 16 carbon atoms.

For example, R₁₂ is a divalent hydrocarbyl (for example alkylene) having 1 to 12, or 1 to 6, or 1 to 4, or 2 to 12, or 2 to 6, or 3 to 12, or 3 to 6 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO.

In an embodiment, the compound (5) containing a carboxyl and a mercapto group (—SH) is compound of Formula (B5)

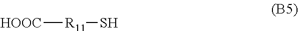

wherein R₁₁ is a divalent organic group having 1 to 20 or 2 to 16 carbon atoms.

For example, R₁₁ is a divalent hydrocarbyl (for example alkylene) having 1 to 12 or 1 to 6 or 1 to 4 carbon atoms, which can optionally be interrupted by one or more non adjacent oxygen atoms, and/or one or more non adjacent carbon atoms in the divalent hydrocarbyl (for example alkylene) can optionally be replaced with —(CO)—O— and/or CO.

In an embodiment, the compound (1) is a compound of Formula (B)

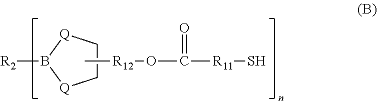

wherein R₂, Q, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

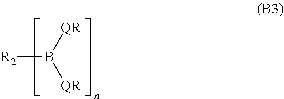

wherein R is selected from H or C₁-C₆-alkyl, for example H, and R₂, Q and n are as defined above,
with a polyol-type compound (4) selected from a compound of Formulae (B4)

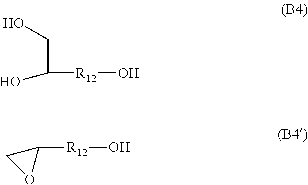

wherein R₁₂ is as defined above,
to obtain a reaction mixture (2), and
reacting the reaction mixture (2) with a compound (5) selected from a compound of Formula (B5)

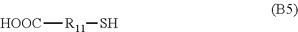

wherein R₁₁ is as defined above,
to obtain a compound of Formula (B).

In an embodiment, the compound (1) is a compound of Formula (D)

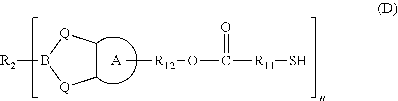

wherein R₂, Q, A, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

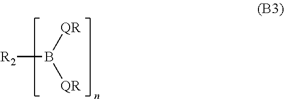

wherein R is selected from H or C₁-C₆-alkyl, for example H, and
R₂, Q and n are as defined above,
with a polyol-type compound (4) selected from a compound of Formulae (D4) and (D4′)

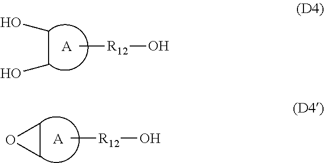

wherein A and R₁₂ are as defined above,
to obtain a reaction mixture (2), and
reacting the reaction mixture (2) with a compound (5) selected from a compound of Formula (B5)

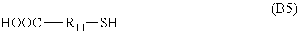

wherein R₁₁ is as defined above,
to obtain a compound of Formula (D).

In an embodiment, the compound (1) is a compound of Formula (F)

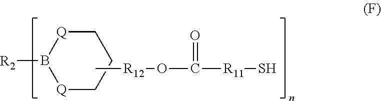

wherein R₂, Q, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

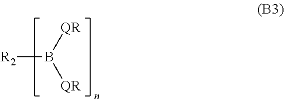

wherein R is selected from H or C₁-C₆-alkyl, for example H, and
R₂, Q and n are as defined above,
with a polyol-type compound (4) selected from a compound of Formulae (F4) and (F4′),

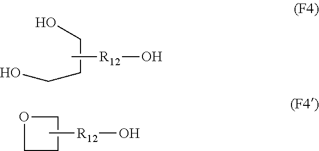

wherein R₁₂ is as defined above,
to obtain a reaction mixture (2), and
reacting the reaction mixture (2) with a compound (5) selected from a compound of Formula (B5)

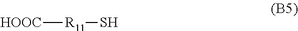

wherein R₁₁ is as defined above,
to obtain a compound of Formula (F).

In an embodiment, the compound (1) is a compound of Formula (H)

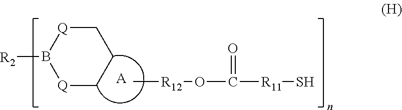

wherein R₂, Q, A, R₁₁, R₁₂ and n are as defined above, or two -Q-B-Q-moieties share one B atom and form a spiro ring;
wherein the process comprises reacting a B-containing compound (3) selected from a compound having a structure of B(QR)₃ and a compound of Formula (B3)

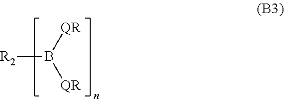

wherein R is selected from H or C₁-C₆-alkyl, for example H, and R₂, Q and n are as defined above,
with a polyol-type compound (4) selected from a compound of Formulae (H4) and (H4′)

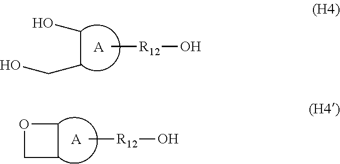

wherein A and R₁₂ are as defined above,
to obtain a reaction mixture (2), and
reacting the reaction mixture (2) with a compound (5) selected from a compound of Formula (B5)

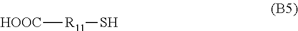

wherein R₁₁ is as defined above,
to obtain a compound of Formula (H).

In an embodiment, each R₁₁ is independently a divalent hydrocarbyl having 1 to 20 or 2 to 16 carbon atoms;
each R₁₂ is independently a divalent hydrocarbyl having 1 to 20 or 2 to 16 carbon atoms;
each R₂ is independently a direct bond or a hydrocarbyl having 1 to 20 or 1 to 18 carbon atoms;
wherein the above hydrocarbyl can optionally be interrupted by one or more non adjacent oxygen atoms, and/or one or more non adjacent carbon atoms in the hydrocarbyl can optionally be replaced with —(CO)—O— and/or CO.

In an embodiment, solvent S1 is produced and removed during the reaction of the B-containing compound (3) with the polyol-type compound (4), and/or solvent S2 is produced and removed during the reaction of the reaction mixture (2) with compound (5).

If the group R in the B-containing compound (3) is H, then solvent S1 produced is water during the reaction of the B-containing compound (3) with the polyol-type compound (4). If the group R in the B-containing compound (3) is C₁-C₆-alkyl, then solvent S1 produced is corresponding alcohol during the reaction of the B-containing compound (3) with the polyol-type compound (4). For example, if the group R in the B-containing compound (3) is methyl, then the solvent S1 produced is methanol.

In this disclosure, solvent S2 produced is water during the reaction of the reaction mixture (2) with compound (5).

In a preferred embodiment, the solvent S1 and/or solvent S2 is removed by a trapping agent, such as magnesium sulphate or molecular sieve or by using a Dean-Stark apparatus or by distillation. The trapping agent can be a water trapping agent, for example magnesium sulphate or molecular sieve.

In an embodiment, the reaction of the B-containing compound (3) with the polyol-type compound (4), and/or reaction of the reaction mixture (2) with compound (5) are carried out in the presence of a sulfonic acid, for example toluenesulfonic acid. The amount of sulfonic acid can be in the range from 0.1 to 1.5 wt % (for example 0.2 wt %, 0.3 wt %, 0.4 wt %, 0.5 wt %, 0.6 wt %, 0.8 wt %, 1 wt %, 1.2 wt %, or 1.4 wt %), based on the weight of the B-containing compound (3).

In an embodiment, the polyol-type compound (4) and compound (5) are used in stoichiometric amount to in an excess of 15% of the stoichiometric amount (for example in an excess of 2%, 4%, 5%, 6%, 8%, 10%, 12% or 14% of the stoichiometric amount), or in an excess of 2% of the stoichiometric amount to in an excess of 10% of the stoichiometric amount, based on the B-containing compound (3).

In an embodiment, the reaction of the B-containing compound (3) with the polyol-type compound (4), and the reaction of the reaction mixture (2) with compound (5) are carried out at a temperature of 105° C. to 180° C. (for example 110° C., 120° C., 140° C., 160° C. or 170° C.) or 110° C. to 155° C., preferably under reflux.

In an embodiment, the reaction of the B-containing compound (3) with the polyol-type compound (4), and the reaction of the reaction mixture (2) with compound (5) are preferably carried out at inert atmosphere, for example at nitrogen atmosphere. The reaction time of the B-containing compound (3) with the polyol-type compound (4), and the reaction time of the reaction mixture (2) with compound (5) can be in the range from 3 hours to 30 hours (for example 5 hours, 10 hours, 15 hours, 20 hours, 25 hours or 30 hours), or 5 hours to 25 hours, respectively. The reaction in the process of this disclosure can be carried out in the presence of a solvent, for example an aromatic hydrocarbon, such as toluene. The reaction in the process of this disclosure can be carried out under stirring.

After the completion reaction, the reaction mixture can be filed and dried to remove the solvent.

In an aspect, this disclosure provides compound (1) containing at least two reversible borate moieties or derivative thereof and at least two mercapto groups (—SH) obtainable by the one-pot process of this disclosure. Details of compound (1) are as mentioned above.

### Process of Preparing a Polyolefin Vitrimer and the Polyolefin Vitrimer

In an aspect, this disclosure provides a process of preparing a polyolefin vitrimer comprising:

(i) preparing compound (1) containing at least two reversible borate moieties or derivative thereof and at least two mercapto groups (—SH) via the one-pot process of this disclosure; and
(ii) reacting the polyolefin containing double bonds with compound (1) to obtain the polyolefin vitrimer.

As used herein, the term “polyolefin” refers to a polymer comprising at least 50 wt % (for example 60 wt %, 70 wt %, 80 wt %, or 90 wt %) monoolefin-derived units, examples of which include ethylene and C₃₋₁₆ monoolefins, (for example C₃₋₁₂ monoolefins, C₃₋₈ monoolefins or C₃₋₆ monoolefins), preferably alpha-monoolefins, and combinations thereof. Examples of the monoolefin include ethylene, propylene, 1-butene, isobutylene, 2-butene, cyclobutene, 1-pentene, 1-hexene, 4-methyl-1-pentene, 1-octene, 3-methyl-1-butene, 4-methyl-1-butene, cyclopentene, 1-hexene, cyclohexene, 1-octene, 1-decene, 1-dodecene, etc. These may be used singly or in combinations of two or more kinds thereof. In certain preferred embodiments, the polyolefins are those that comprise at least 50 wt % (for example 60 wt %, 70 wt %, 80 wt %, or 90 wt %) of ethylene, or propylene, or butene-derived units or combination thereof.

The polyolefin of this disclosure comprises polyene (for example diene)-derived units. The polyene may be any hydrocarbon structure having at least two unsaturated bonds wherein at least one of the unsaturated bonds is readily incorporated into a polymer. For example, the polyene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of polyene-derived units can be in the range from 1 wt % to 15 wt % (for example 1 wt %, 2 wt %, 3 wt %, 4 wt %, 5 wt %, 6 wt %, 8 wt %, 10 wt %, 12 wt % or 14 wt %), or from 1 to 14 wt %, or from 2 to 12 wt %, or from 3 to 10 wt %, or from 3 to 8 wt %, based on the total weight of the polyolefin.

The polyolefin may be a random copolymer (the comonomer-derived units are randomly distributed along the polymer backbone), a block copolymer (the comonomer-derived units occur along long sequences), or any variation thereof. The presence of randomness or triad tacticity in a copolymer can be determined by ¹³C NMR as is known in the art and described in, for example, 18 J. Poly. Sci.: Poly. Lett. Ed. pp. 389-394 (1980).

In certain embodiments, the polyolefin may have a Shore A hardness of from a lower limit of about 10, about 20, about 30, about 40, about 50, or about 60 to an upper limit of about 70, about 75, about 80, about 85, about 90, or about 95, as determined by ASTM D2240.

The polyolefin may have a Mooney viscosity ML (1+4) at 125° C., as determined according to ASTM D1646, of at least 10 MU (for example 15 MU, 20 MU, 25 MU, 30 MU, 40 MU, 50 MU, 60 MU, 80 MU, or 100 MU), or at least 15 MU, or at least 20 MU. In an embodiment, the polyolefin may have a Mooney viscosity ML (1+4) at 125° C., as determined according to ASTM D1646, of from 10 to 100 MU, or from 15 to 80 MU, or from 20 to 60 MU.

In an embodiment, the polyolefin may have a melt flow rate (MFR), as determined by ASTM D1238, 2.16 kg at 230° C., of greater than about 0.1 g/10 min, about 0.5 g/10 min, about 1 g/10 min, about 2 g/10 min, about 5 g/10 min, or about 10 g/10 min, and preferably up to about 20 g/10 min, about 40 g/10 min, about 80 g/10 min, about 100 g/10 min, or about 200 g/10 min.

The polyolefin may have a weight average molecular weight (M_{w}) of about 5,000 to about 5,000,000 g/mole, preferably about 10,000 to about 1,000,000 g/mole, and more preferably about 50,000 to about 400,000 g/mole; a number average molecular weight (Mₙ) of about 2,500 to about 250,000 g/mole, preferably about 10,000 to about 250,000 g/mole, and more preferably about 25,000 to about 250,000 g/mole; and/or a z-average molecular weight (M_{z}) of about 10,000 to about 7,000,000 g/mole, preferably about 80,000 to about 700,000 g/mole, and more preferably about 100,000 to about 500,000 g/mole. The propylene-based elastomer may have a molecular weight distribution (“MWD”) of about 1.5 to about 20, or about 1.5 to about 15, preferably about 1.5 to about 5, and more preferably about 1.8 to about 3, and most preferably about 1.8 to about 2.5.

In certain embodiments, the polyolefin of this disclosure has a density, as determined by ASTM D1505, of from about 0.83 g/cm³ to about 0.9 g/cm³, preferably from about 0.85 g/cm³ to about 0.89 g/cm³, from about 0.86 g/cm³ to about 0.88 g/cm³, or from about 0.86 g/cm³ to about 0.87 g/cm³.

In certain embodiments, the polyolefin of this disclosure has a flexural modulus at 1% Secant (73° F.) (23° C.), as determined by ASTM D790, of from about 8 MPa to about 100 MPa.

In an embodiment, the polyolefin is selected from the propylene-based polyolefin and the ethylene-based polyolefin, and EPDM polymer.

In an embodiment, the polyolefin of this disclosure is a propylene-based polyolefin (for example elastomer) comprising at least about 60 wt % propylene-derived units and about 5 to about 25 wt % ethylene-derived units, based on total weight of the propylene-based polyolefin, wherein the propylene-based polymer has a heat of fusion of less than about 80 J/g. The propylene-based polymer is a copolymer of propylene-derived units and units derived from at least one of ethylene or a C₄-C₁₀ olefin (for example C₄-C₈ olefin or C₄-C₅ olefin), preferably alpha-olefin. Examples of the olefin include 1-butene, isobutylene, 2-butene, cyclobutene, 1-pentene, 1-hexene, 4-methyl-1-pentene, 1-octene, 3-methyl-1-butene, 4-methyl-1-butene, cyclopentene, 1-hexene, cyclohexene, 1-octene, 1-decene, etc. The propylene-based polymer has limited crystallinity due to adjacent isotactic propylene units and a melting point as described herein. The crystallinity and the melting point of the propylene-based polymer are reduced compared to highly isotactic polypropylene by the introduction of errors in the insertion of propylene. The propylene-based polymer is generally devoid of any substantial intermolecular heterogeneity in tacticity and comonomer composition, and also generally devoid of any substantial heterogeneity in intramolecular composition distribution.

The units, or comonomers, derived from at least one of ethylene or a C₄-C₁₀ olefin may be present in the propylene-based polymer in an amount of about 1 to about 35 wt %, or about 5 to about 35 wt %, preferably about 7 to about 32 wt %, more preferably about 8 to about 25 wt %, even more preferably about 8 to about 20 wt %, and most preferably about 8 to about 18 wt % of the propylene-based polymer. The propylene-based polymer may have a heat of fusion of less than about 80 J/g. The propylene-based polymer may have a melting point of about 105° C. or less. The propylene-based polymer may have a crystallinity of about 2% to about 65% of isotactic polypropylene. The propylene-based polymer may have a MFR of about 1.5 to about 20 g/10 min, or of about 2 to about 20 g/10 min, or of about 2 to about 15 g/10 min, or of about 2 to about 10 g/10 min, or of about 2 to about 8 g/10 min.

Exemplary polyolefin useful in this invention may include ethylene-based polyolefins (for example elastomer). Useful ethylene-based polyolefins may have one or more of the following properties:
(1) an ethylene content of about 60 wt % to about 90 wt %, preferably about 65 wt % to about 85 wt %, preferably about 65 wt % to about 80 wt %, preferably about 65 wt % to about 75 wt %;
(2) an ethylene content of about 80 mol % to about 96 mol %, preferably about 82 mol % to about 92 mol %, preferably about 82 mol % to about 88 mol %, preferably about 84 mol % to about 86 mol %;
(3) a propylene content of about 10 wt % to about 20 wt %;
(4) a 1-butene content of about 15 wt % or more, preferably about 20 wt % or more, preferably about 25 wt % or more;
(5) a 1-hexene content of about 20 wt % or more, preferably about 25 wt % or more, preferably about 30 wt % or more;
(6) a 1-octene content of about 25 wt % or more, preferably about 30 wt % or more, preferably about 35 wt % or more;
(7) a density of about 0.9 g/cm³ or less, preferably 0.89 g/cm³ or less, preferably 0.88 g/cm³ or less, preferably 0.87 g/cm³ or less, preferably 0.86 g/cm³ or less, preferably 0.83 g/cm³ or more, preferably 0.84 g/cm³ or more, preferably 0.85 g/cm³ or more, preferably 0.855 g/cm³ or more, preferably about 0.83 g/cm³ to about 0.9 g/cm³, preferably from about 0.85 g/cm³ to about 0.89 g/cm³, preferably from about 0.85 g/cm³ to about 0.88 g/cm³, or preferably from about 0.85 g/cm³ to about 0.87 g/cm³;
(8) a heat of fusion (Hf) of about 90 J/g or less, preferably about 70 J/g or less, preferably about 50 J/g or less, preferably about 30 J/g or less, preferably about 10 J/g to 70 J/g, preferably about 10 J/g to about 50 J/g, preferably about 10 J/g to about 30 J/g;
(9) a crystallinity of about 40% or less, preferably about 30% or less, preferably about 20% or less, and at least about 5%, preferably about 5% to about 30%, preferably about 5% to about 20%;
(10) a melting point (Tₘ, peak first melt) of about 100° C. or less, preferably about 90° C. or less, preferably about 80° C. or less, preferably about 70° C. or less, preferably about 60° C. or less, preferably about 50° C. or less;
(11) a crystallization temperature (T_{c}, peak) of about 90° C. or less, preferably about 80° C. or less, preferably about 70° C. or less, preferably about 60° C. or less, preferably about 50° C. or less, preferably about 40° C. or less;
(12) a glass transition temperature (T_{g}) of about −20° C. or less, preferably about −30° C. or less, preferably about −40° C. or less;
(13) a M_{w} of about 30,000 g/mol to about 2,000,000 g/mol, preferably about 50,000 g/mol to about 1,000,000 g/mol, preferably about 90,000 g/mol to about 500,000 g/mol;
(14) a M_{w}/Mₙ of about 1 to about 40, preferably about 1.4 to about 20, preferably about 1.6 to about 10, preferably about 1.8 to about 3.5, preferably about 1.8 to about 2.5;
(15) a branching index (g′) of about 0.9 or greater, preferably about 0.95 or greater, preferably about 0.99 or greater; and
(16) a melt index (MI) of about 0.1 g/10 min to about 100 g/10 min, preferably about 0.3 g/10 min to about 60 g/10 min, preferably about 0.5 g/10 min to about 40 g/10 min, preferably about 0.7 g/10 min to about 20 g/10 min.

Exemplary polyolefin useful in this invention may include EPDM polymers. The EPDM polymers are low unsaturation polymers and intended to mean terpolymers containing ethylene and propylene and a diene. The preferred polymers contain about 45 wt % to about 65 wt % ethylene, more preferably 45 wt % to 60 wt % e.g., 50 wt % ethylene and about 1 wt % to about 10 wt % (for example 2 wt %, 4 wt %, 6 wt % or 8 wt %) of diene monomer, the balance of the polymer being propylene. The diene monomer is preferably a nonconjugated diene, such as polyene as mentioned above. Illustrative of these nonconjugated diene monomers which may be used in the terpolymer (EPDM) are 1,4-hexadiene, dicyclopentadiene, 5-ethylidene 2-norbornene, 5-methylene-2-norbornene, 5-propenyl-2-norbornene, and methyl tetrahydroindene.

In step (ii) of the process of preparing the polyolefin vitrimer, the amount of compound (1) is in the range from 1 wt % to 25 wt % (for example 1.2 wt %, 1.5 wt %, 1.8 wt %, 2 wt %, 3 wt %, 5 wt %, 8 wt %, 10 wt %, 12 wt %, 15 wt %, 18 wt %, 20 wt %, or 22 wt %) or from 1.2 wt % to 20 wt %, or from 1.5 wt % to 15 wt %, based on the weight of the polyolefin containing double bonds.

In an embodiment, compound (1) is in the form of liquid. The amount of compound (1) can be in the range from 1 ml to 25 ml (for example 1.2 ml, 1.5 ml, 1.8 ml, 2 ml, 3 ml, 5 ml, 8 ml, 10 ml, 12 ml, 15 ml, 18 ml, 20 ml, or 22 ml) or from 1.2 ml to 20 ml, or from 1.5 ml to 15 ml, based on 100 g of the polyolefin containing double bonds.

The reaction of the polyolefin containing double bonds with compound (1) is carried out in the presence of a free-radical polymerization initiator, such as a thermal or UV initiator.

Suitable free-radical polymerization initiator can include for example peroxide initiator and azo compound.

Suitable peroxides are, for example, acetylcyclohexanesulfonyl peroxide, diisopropyl peroxydicarbonate, t-amyl perneodecanoate, t-butyl perneodecanoate, t-butyl perpivalate, t-amyl perpivalate, bis(2,4-dichlorobenzoyl) peroxide, diisononanoyl peroxide, didecanoyl peroxide, dioctanoyl peroxide, dilauroyl peroxide, bis(2-methylbenzoyl) peroxide, disuccinoyl peroxide, diacetyl peroxide, dibenzoyl peroxide, t-butyl per-2-ethylhexanoate, bis(4-chlorobenzoyl) peroxide, t-butyl perisobutyrate, t-butyl permaleate, 1,1-bis(t-butylperoxy)-3,5,5-trimethylcyclohexane, 1,1-bis(t-butylperoxy)cyclohexane, t-butylperoxy isopropyl carbonate, t-butyl perisononanoate, t-butyl peracetate, t-amyl perbenzoate, t-butyl perbenzoate, 2,2-bis(t-butylperoxy) butane, 2,2-bis-(t-butylperoxy) propane, dicumyl peroxide, 2,5-dimethyl-2,5-bis(t-butylperoxy) hexane, 3-(t-butylperoxy)-3-phenylphthalide, di(t-amyl) peroxide, α,α′-bis(t-butylperoxyisopropyl)benzene, 3,5-bis(t-butylperoxy)-3,5-dimethyl-1,2-dioxolane, di(t-butyl) peroxide, 2,5-dimethyl-2,5-bis(t-butylperoxy) hexyne, 3,3,6,6,9,9-hexamethyl-1,2,4,5-tetraoxacyclononane, p-menthane hydroperoxide, pinane hydroperoxide, diisopropylbenzene, mono-α-hydroperoxide, cumene hydroperoxide or t-butyl hydroperoxide.

Suitable azo compounds are for example azobis isobutyronitrile (AIBN), azobis (2,4-dimethylvalero) nitrile, and azobis(2-methylbutyro) nitrile.

The amount of the free-radical polymerization initiator can be in the range from 0.01 wt % to 0.5 wt % (for example 0.02 wt %, 0.04 wt %, 0.05 wt %, 0.08 wt %, 0.1 wt %, 0.2 wt %, or 0.4 wt %), or from 0.02 wt % to 0.4 wt %, based on the weight of the polyolefin containing double bonds.

The reaction for preparing the vitrimer in step (ii) can be carried out at from 50° C. to 160° C. (for example 60° C., 80° C., 100° C., 120° C., 140° C. or 150° C.), or from 60° C. to 140° C. The reaction time can be in the range from 2 hours to 20 hours, or 5 hours to 15 hours. The reaction for preparing the vitrimer in step (ii) can be carried out in the presence of a solvent, such as toluene.

According to the present invention, step (ii) can be carried out in a one-step process.

In an embodiment, the vitrimer can undergo separation. For separating the vitrimer obtained from the polymerization, the vitrimer may be precipitated (for example in methanol), and filtered, and dried.

In an aspect, this disclosure provides a polyolefin vitrimer prepared with the polyolefin containing double bonds and the compound (1).

In an embodiment, the polyolefin vitrimer meets at least one of following requirements:
(r-1) the tensile stress at 400% strain of the polyolefin vitrimer is at least 350% (for example 400%, 450%, 500%, 600%, 700%, 800%, 900%, 1000%, 1200%, 1500%, 1800%, 2000%, 2500%, 2800%, or 3000%), or at least 450%, or at least 600%, or at least 800%, or at least 1200% of the tensile stress at 400% strain of the neat polyolefin; or the tensile stress at 400% strain of the polyolefin vitrimer is 350% to 3000%, or 450% to 2800%, or 600% to 2500% of the tensile stress at 400% strain of the neat polyolefin;
(r-2) the storage modulus of the polyolefin vitrimer tested by dynamic frequency sweeps at 50° C. and at a frequency of 6.283×10⁻⁴ rad/s is at least 1 (for example 1, 1.2, 1.5, 1.8, 2, 2.2, 2.5, 2.8 or 3), or at least 1.5 orders of magnitude larger than that of the neat polyolefin; or the storage modulus of the polyolefin vitrimer tested by dynamic frequency sweeps at 50° C. and at a frequency of 6.283×10⁻⁴ rad/s is 1 to 3, or 1.2 to 2.8, or 1.5 to 2.5 orders of magnitude larger than that of the neat polyolefin;
(r-3) the complex viscosity of the polyolefin vitrimer tested by dynamic frequency sweeps at 50° C. and at a frequency of 6.283×10⁻⁴ rad/s is at least 0.5 (for example 0.8, 1, 1.2, 1.5, 1.8 or 2), or at least 1 order of magnitude larger than that of the neat polyolefin; or the complex viscosity of the polyolefin vitrimer tested by dynamic frequency sweeps at 50° C. and at a frequency of 6.283×10⁻⁴ rad/s is 0.5 to 3, or 0.8 to 2.5, or 1 to 2 orders of magnitude larger than that of the neat polyolefin;
(r-4) the polyolefin vitrimer displays extensional strain hardening.

In an embodiment, the polyolefin vitrimer meets at least two, or at least three or all of above requirements.

The vitrimer of this disclosure shows high zero-shear viscosity (for example at a frequency of 6.283×10⁻⁴ rad/s), and low high-shear viscosity (for example at a frequency of 102.5 rad/s).

The specimens for tensile and hysteresis tests are dog bone-shaped specimens (0.3 mm×2 mm×7 mm). For example, the specimens can be prepared by compression molding in a hot press preheated at 100° C. 7 mm gauge length and 0.1 mm/s uniaxial deformation rate and a 35 N load cell are used for the tensile tests. Tensile and hysteresis tests can be performed in a Dynamic Solid Analyzer RSA-G2 (TA Instruments).

The polyolefin vitrimer of this disclosure also shows improved shear-thinning behavior comparing with the neat polyolefin. The polyolefin vitrimer shows high zero-shear viscosity, and low high-shear viscosity.

The storage modulus of the polyolefin vitrimer is at least about 180%, at least about 200%, at least about 250%, at least about 300%, at least about 350%, at least about 400%, at least about 450%, at least about 500%, or at least about 550%, or at least about 600%, or at least about 700% of the storage modulus of the neat polyolefin, at 220° C. and 0.0001 Hz (=6.283×10⁻⁴ rad/s) tested by dynamic thermal-mechanical analysis at a heating rate of 2° C./min. In an embodiment, the storage modulus of the polyolefin vitrimer is about 180% to about 1500%, or about 200% to about 1400%, or about 250% to about 1300%, or about 300% to about 1200%, or about 350% to about 1200%, or about 400% to about 1200% of the storage modulus of the neat polyolefin, at 220° C. and 0.0001 Hz (=6.283× 104 rad/s) tested by dynamic thermal-mechanical analysis at a heating rate of 2° C./min.

Unlike traditional crosslinked material, the vitrimer of this disclosure could be remold and reprocess.

The vitrimer of this disclosure has thermoplastic property, preferably is able to be processed by pressing, injection molding, extrusion molding, blow molding, calendering, foaming, solvent plasticizing, mold pressing, casting, reaction molding, for example by granulation and further hot press or extrusion. By “thermoplastic polymer(s)” is meant a polymer that can be melted by heat and then cooled without appreciable change in solid-state properties before and after heating.

### Composition

A further aspect of this disclosure is directed to a composition comprising the polyolefin vitrimer of this disclosure and at least one additive. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates and hydrogenated rosins; UV stabilizers; heat stabilizers; antiblocking agents; release agents; anti-static agents; pigments; colorants; dyes; waxes; silica; fillers; talc; modifier; and the like.

### Blending and Processing of Vitrimer and Composition

The vitrimer and composition described herein may be processed or formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twinscrew extruder, which may include a compounding extruder and a side-arm extruder used directly downstream of a polymerization process. Additionally, additives may be included in the polymer, blend, in one or more components of the blend, and/or in a product formed from the blend, such as a film, as desired. Examples of additives are as described above.

The vitrimer can be in any physical form. In an embodiment, reactor granules, defined as the granules of vitrimer that are isolated from the polymerization reactor prior to any processing procedures, are used. In another embodiment, the vitrimer is in the form of pellets that are formed from melt extrusion. The vitrimer can be in above mentioned physical form when used to blend with the additive.

The components can be blended by any suitable means, and are typically blended to yield an intimately mixed composition. For example, they may be blended in a static mixer, batch mixer, extruder, or a combination thereof, that is sufficient to achieve an adequate dispersion of additive in the vitrimer.

The mixing step may involve first dry blending using, for example, a tumble blender, where the vitrimer and additive are brought into contact first, without intimate mixing, which may then be followed by melt blending in an extruder. Another method of blending the components is to melt blend the vitrimer pellets with the additive directly in an extruder or batch mixer. It may also involve a “master batch” approach, where the final additive concentration is achieved by combining vitrimer with an appropriate amount of additive that had been previously prepared at a higher additive concentration. The mixing step may take place as part of a processing method used to fabricate articles, such as in the extruder on an injection molding machine or blown-film line or fiber line.

In a preferred aspect of this disclosure, the vitrimer and additive are “melt blended” in an apparatus such as an extruder (single or twin screw) or batch mixer. The vitrimer may also be “dry blended” with the additive using a tumbler, double-cone blender, ribbon blender, or other suitable blender. In yet another embodiment, the vitrimer and additive are blended by a combination of approaches, for example a tumbler followed by an extruder. A preferred method of blending is to include the final stage of blending as part of an article fabrication step, such as in the extruder used to melt and convey the composition for a molding step like injection molding or blow molding. This could include direct injection of the additive into the extruder, either before or after the vitrimer is fully melted. Extrusion technology for polymer can reference, for example, Plastics Extrusion Technology 26-37 (Friedhelm Hensen, ed. Hanser Publishers 1988).

In another aspect of this disclosure, the composition may be blended in solution by any suitable means, by using a solvent that dissolves components to a significant extent. The blending may occur at any temperature or pressure where the additive and the vitrimer remain in solution. As with the solution process the additive is added directly to the finishing train, rather than added to the dry vitrimer in another blending step altogether.

Thus, in the cases of fabrication of articles using methods that involve an extruder, such as injection molding or blow molding, any means of combining the vitrimer and additive to achieve the desired composition serve equally well as fully formulated pre-blended pellets, since the forming process includes a re-melting and mixing of the raw material; example combinations include simple blends of vitrimer pellets and additive, of vitrimer granules and additive, of vitrimer pellets and pre-blended pellets, and vitrimer granules and pre-blended pellets. Here, “pre-blended pellets” means pellets of a composition comprising vitrimer and additive at some concentration. In the process of compression molding, however, little mixing of the melt components occurs, and pre-blended pellets would be preferred over simple blends of the constituent pellets (or granules) and additive. Those skilled in the art will be able to determine the appropriate procedure for blending of the vitrimer to balance the need for intimate mixing of the component ingredients with the desire for process economy.

### Article

A further aspect of the present invention is directed to an article comprising the vitrimer, the vulcanized vitrimer or the composition of this disclosure.

The article can be an extruded article, molded article, hose, sheet, film, jacket or foam. For example, the article includes, but are not limited to, an extruded article, such as an auto weather-seal, a non-auto weather-seal, a building profile, etc.; a molded article, such as a seal, a gasket, etc.; a hose, such as air hose, heat hose, garden hose, industry hose, etc.; a sheet, such as a roof sheet; a film; a jacket, such as a cable jacket, or a foam.

### EXAMPLES

### Material

EPDM Vistalon 2504: an EPDM polymer of 58 wt % Ethylene, 37.3 wt % propyelene and 4.7 wt % Ethylidene norbornene; Mooney viscosity: 25 MU (ML 1+4, 257° F. $ (125° C.)).

### Example 1: One-Pot Synthesis of Diborondithiol (Dbdt) Crosslinker

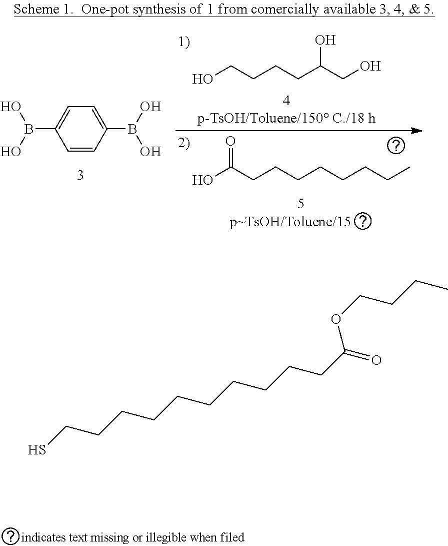 [SMILES: OCCCCC(O)CO ; OB(O)c1ccc(B(O)O)cc1 ; CCCCCCCCC(=O)O ; CCCCOC(=O)CCCCCCCCCCS]

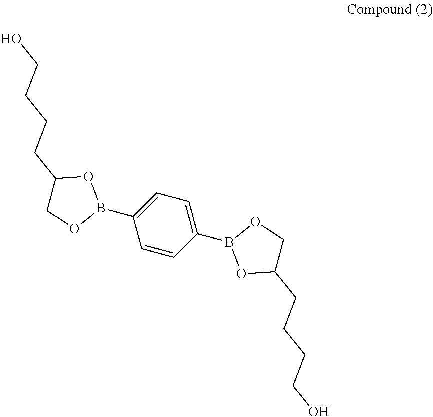 [SMILES: OCCCCC1COB(c2ccc(B3OCC(CCCCO)O3)cc2)O1]

(1,4-phenylenebis(1,3,2-dioxaborolane-2,4-diyl))bis(butane-4,1-diyl)bis(11-mercaptoundecanoate) (DBDT, compound 1) Under nitrogen atmosphere, to a 500 mL single-neck round bottom flask equipped with a magnetic stir bar was added benzene-1,4-diboronic acid 3 (7.60 g, 45.85 mmol), 1,2,6-hexanetriol 4 (12.92 g, 96.29 mmol), anhydrous toluene (150 mL) and p-toluenesulfonic acid (50 mg). The reaction mixture was refluxed at 150° C. with a Dean-Stark trap for 18 hours. Next day, after the reaction mixture was cooled to 90° C., 11-Mercaptoundecanoic acid 5 (21.03 g, 96.29 mmol) was added. The reaction mixture was then refluxed at 150° C. with a Dean-Stark trap for another 18 hours. After cooled down to room temperature, the reaction mixture was filtered to remove any solid in the solution. The solvent in the collected filtrate was removed by rotary evaporation under reduced pressure to afford a yellow viscous oil 1 (34.1 g, 99% yield). Based on 1H NMR analysis, the yellow oil 1 contained trace amount of unreacted intermediate compound 2 (about 2.7 mol %) and residue of toluene solvent. 1H NMR (500 MHz, CDCl₃) δ 7.81 (s, 4H), 4.57 (m, 2H), 4.44 (t, 2H), 4.10 (t, 4H), 3.95 (t, 2H), 2.50 (q, 4H), 2.29 (t, 4H), 1.80-1.20 (m, 44H).

Reaction completion was monitored by 1H NMR using the disappearance of proton signal at 3.67 ppm and the formation of proton signal at 4.09 ppm.

### Example 2: Synthesis of EPDM Vitrimers

For preparing samples 2, 3, 4 and 5, four raw materials of 5 g of EPDM Vistalon 2504 (EPDM) were dissolved in toluene at 80° C. with magnetic stirring. AIBN and a solution of the boronic crosslinker (DBDT, product 1 in Scheme 1) in toluene (10% v/v) were added to the EPDM solutions according to the quantities listed in Table 1. The solutions were allowed to react for 12 hours, after which the products were precipitated in methanol, and filtrated from the solvent mixture. Traces of solvent were removed in the vacuum oven at 90° C. for 3 hours.

TABLE 1
EPDM vitrimers formulations.

| | | | | DBDT 10% | | |
|---|---|---|---|---|---|---|
| | | V2504 | AIBN | solution | DBDT/ | |
| Sample | Description | (g) | (mg) | (ml) | EPDM | |
| 1 | EPDM | 5 | 0 | 0 | 0 | ml/g |
| 2 | EPDM-AIBN | 5 | 100 | 0 | 0 | ml/g |
| 3 | EPDM-V1 | 5 | 100 | 1 | 0.02 | ml/g |
| 4 | EPDM-V2 | 5 | 100 | 2 | 0.04 | ml/g |
| 5 | EPDM-V3 | 5 | 100 | 4 | 0.08 | ml/g |

### Example 3: Characterization of Vitrimers

### Thermal Behavior

The EMPD sample was fully amorphous, i.e., it did not have any crystallinity and, therefore, no melting transition. The glass transition temperature (Tg, measured by DSC at a heating rate of 10° C./min) was not affected by the crosslinking with the DBDT, as shown in Table 2.

TABLE 2

| Sample | Name | Tg (° C.) |
|---|---|---|
| 1 | EPDM | −53.7 |
| 2 | EPDM-AIBN | −52.9 |
| 3 | EPDM -V1 | −53.2 |
| 4 | EPDM -V2 | −53.6 |

### Rheological Response

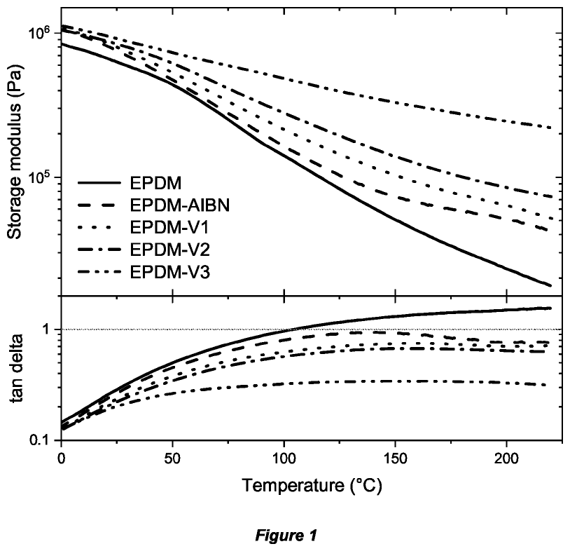

Dynamic thermal-mechanical analysis (DMTA) data of the neat EPDM and the vitrimers were shown in FIG. 1, the temperature ramps were performed at a heating rate of 2° C./min. The neat EPDM showed the typical steady decrease in moduli and the crossover temperature above which storage modulus (G′) became less than G″ (and tan δ>1), which indicated that the polymer lost elasticity and became more “liquid-like”. This crossover was not observed in the vitrimer samples, which indicated that the sample remained highly elastic at temperature up to 220° C. The results of G′ and tan δ at 220° C. and 0.0001 Hz (=6.283×10⁻⁴ rad/s) were also shown in table 3.

TABLE 3

| Sample | Name | G′(kPa) | Tan δ |
|---|---|---|---|
| 1 | EPDM | 23.2 | 1.48 |
| 2 | EPDM-AIBN | 51.9 | 0.766 |
| 3 | EPDM -V1 | 64.2 | 0.699 |
| 4 | EPDM -V2 | 85.3 | 0.647 |
| 5 | EPDM -V3 | 245 | 0.328 |

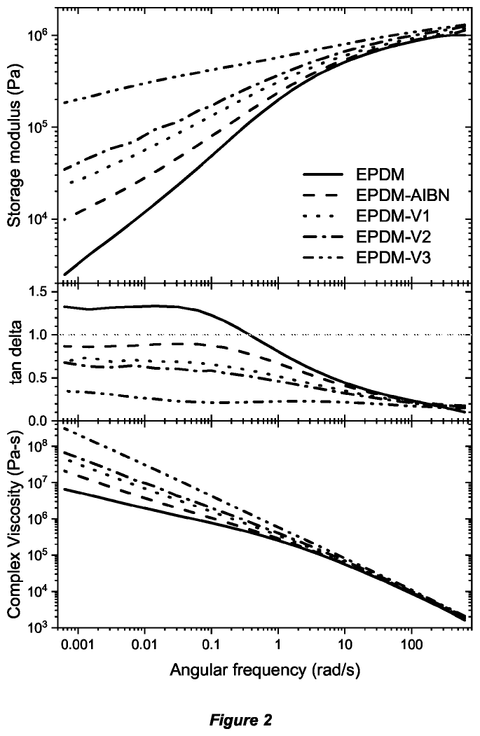

Additional evidence of network formation was provided in FIG. 2, which showed the dynamic frequency sweeps (DFS), measured at 50° C., of the neat EPDM and the vitrimer samples. The neat polymer showed the typical crossover moduli (marked by the transition in tan δ from values <1 to >1). The low-frequency storage modulus in the vitrimers increased as a function of DBDT, and reached up to two orders of magnitude larger in EPDM-V3 than that in the neat polymer. This and the pseudo plateau in G′ at low frequencies indicated solid-like behavior in this sample. The results of Storage modulus, tan δ and complex viscosity at a frequency of (0.0001 Hz=6.283× 10⁻⁴ rad/s) tested by DFS under 50° C. were also shown in table 4.

TABLE 4

| | | Storage modulus | | Complex viscosity |
|---|---|---|---|---|
| Sample | Name | (kPa) | Tan δ | (Pa · s) |
| 1 | EPDM | 2.47 | 1.33 | 6.54 × 10⁶ |
| 2 | EPDM-AIBN | 9.89 | 0.867 | 2.08 × 10⁷ |
| 3 | EPDM -V1 | 23.5 | 0.688 | 4.56 × 10⁷ |
| 4 | EPDM -V2 | 34.7 | 0.679 | 6.67 × 10⁷ |
| 5 | EPDM -V3 | 184 | 0.348 | 3.11 × 10⁸ |

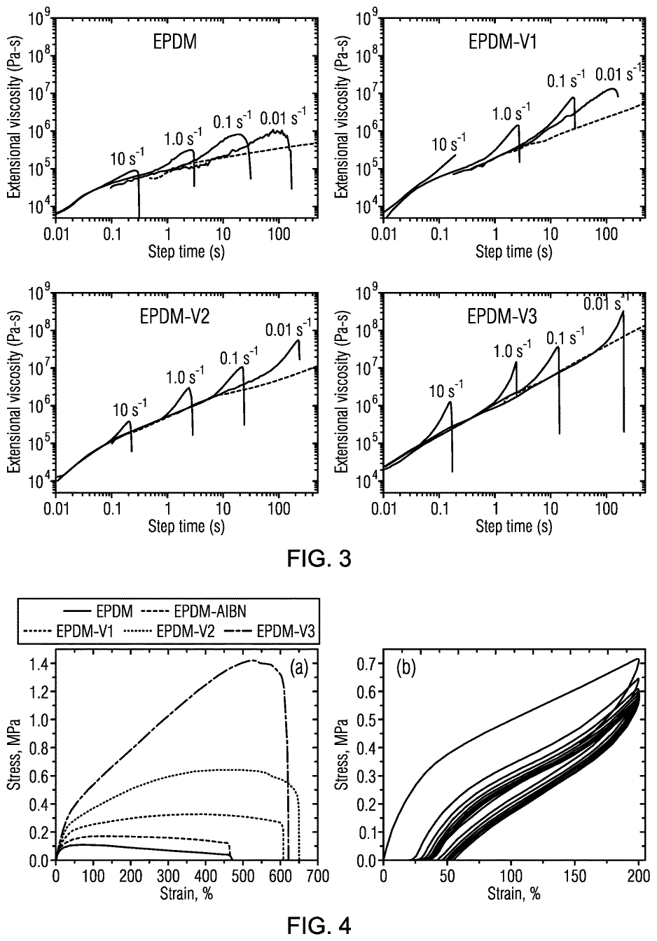

The viscosity plots in FIG. 2 showed that the low viscosity data of the vitrimer sample EPDM-V3 was at least two orders of magnitude larger than the neat polymer. This indicated a very high melt strength value in the vitrimer sample. This also suggested that these samples may display extensional strain hardening (SH), which was confirmed by extensional rheology data shown in FIG. 3. These figures compared the extensional viscosity of the neat EPDM and the three vitrimers, measured at 50° C. The neat EPDM sample showed low extensional viscosity and very weak SH. In contrast, the vitrimer samples showed very strong SH. Overall the vitrimers showed superior processability properties (melt strength, shear thinning and SH) compared to the neat EPDM sample.

### Mechanical Properties

The samples listed in Table 1 were compression molded into dog bone-shaped specimens (0.3 mm×2 mm×7 mm) in a hot press preheated at 100° C. Tensile and hysteresis tests were performed in a Dynamic Solid Analyzer RSA-G2 (TA Instruments). 7 mm gauge length and 0.1 mm/s uniaxial deformation rate and a 35 N load cell were used for the tensile tests. For hysteresis tests, 8 cycles of uniaxial deformation to 200% strain were carried out at a deformation rate of 0.1 mm/s. All the tests were performed at a temperature of 22° C. FIG. 4 (a) showed the strong effect of the boron crosslinker on the tensile strength in the EPDM-vitrimers. FIG. 4 (b) showed the elastomeric behavior of sample EPDM-V4 through eight loading-unloading hysteresis cycles. The data of tensile stress at strain=400% of the samples were summarized in table 5.

TABLE 5

| | | Tensile stress at |
|---|---|---|
| Sample | Name | strain = 400% (kPa) |
| 1 | EPDM | 53.9 |
| 2 | EPDM-AIBN | 139 |
| 3 | EPDM -V1 | 331 |
| 4 | EPDM -V2 | 639 |
| 5 | EPDM -V3 | 1242 |

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

What is claimed is:

1. A one-pot process of preparing compound (1), wherein compound (1) contains at least two reversible borate moieties or derivative thereof and at least two mercapto groups (—SH), wherein the derivative of borate moiety represents a moiety with the oxygen in the borate moiety being replaced with other element of the sixth main group, for example sulfur, and there is a reversible borate moiety or derivative thereof between any two mercapto groups;
wherein the process comprises reacting a B-containing compound (3) with a polyol-type compound (4) to obtain a reaction mixture (2), and reacting the reaction mixture (2) with a compound (5) containing a carboxyl and a mercapto group (—SH) to form compound (1),
wherein the B-containing compound (3) is selected from a compound having a structure of B (QR); and a compound having at least two B(QR)₂ groups, wherein R is selected from H or C₁-C₆-alkyl and each Q is independently an element of the sixth main group, or oxygen or sulfur; and
wherein the polyol-type compound (4) has three hydroxyls and two of them are capable of forming the reversible borate moiety or derivative thereof with the B-containing compound (3), or the polyol-type compound (4) has one hydroxyl and one ethylene oxide ring or oxetane ring.

2. The process according to claim 1, wherein the solvent S1 produced is removed during the reaction of the B-containing compound (3) with the polyol-type compound (4), and/or the solvent S2 produced is removed during the reaction of the reaction mixture (2) with compound (5),
preferably the solvent S1 and/or solvent S2 is removed by a trapping agent or by using a Dean-Stark apparatus or by distillation.

3. The process according to claim 1, wherein the reaction of the B-containing compound (3) with the polyol-type compound (4), and/or reaction of the reaction mixture (2) with compound (5) are carried out in the presence of a sulfonic acid.

4. The process according to claim 1, wherein the polyol-type compound (4) and compound (5) are used in stoichiometric amount to in an excess of 15% of the stoichiometric amount, or in an excess of 2% of the stoichiometric amount to in an excess of 10% of the stoichiometric amount, based on the B-containing compound (3).

5. The process according to claim 1, wherein the reaction of the B-containing compound (3) with the polyol-type compound (4), and the reaction of the reaction mixture (2) with compound (5) are carried out at a temperature of 105° C. to 180° C., or 110° C. to 155° C., preferably under reflux.

6. The process according to claim 1, wherein the reversible borate moiety or derivative thereof has a structure of Formula (I): 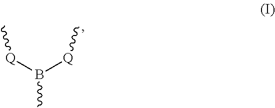
wherein each Q is independently an element of the sixth main group, or oxygen or sulfur.

7. The process according to claim 6, wherein the -Q-B-Q-moiety in Formula (I) forms a boron-containing ring having 5 to 8 ring members together with 2 to 5 carbon atoms, optionally the boron-containing ring is fused with a further ring to form a fused ring system; or two -Q-B-Q-moieties share one B atom and form a spiro ring.

8. The process according to claim 7, wherein the boron-containing ring has the following structure: 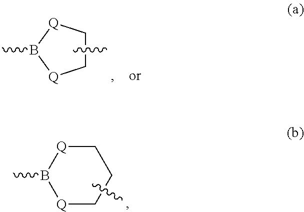
the fused ring system containing the boron-containing ring has the following structure: 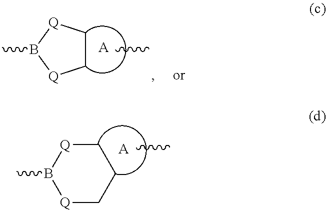
wherein A is a ring having 5 to 10 ring members and wherein each Q is independently an element of the sixth main group;
or two -Q-B-Q-moieties share one B atom and form a spiro ring.

9. The process according to claim 1, wherein the compound (1) is selected from a compound of Formulae (B), (D), (F) and (H) 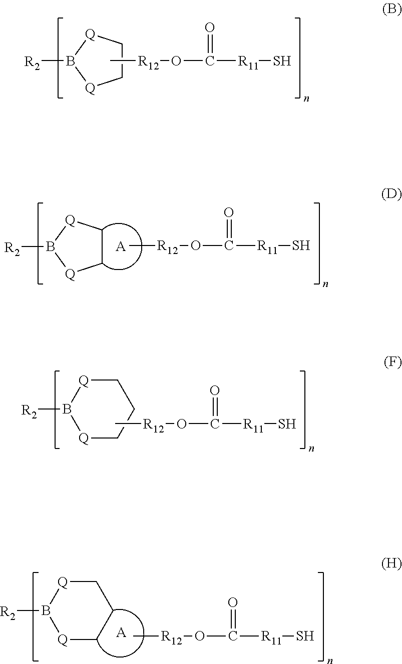
wherein:
each R₁₁ is independently a divalent organic group having 1 to 20 carbon atoms;
each R₁₂ is independently a divalent organic group having 1 to 20 carbon atoms;
each R₂ is independently a direct bond or an organic group having 1 to 20 carbon atoms; or
two -Q-B-Q-moieties share one B atom and form a spiro ring;
each A is independently a ring having 5 to 10 ring members;
each Q is independently an element of the sixth main group, or oxygen or sulfur; and
n is 2, 3 or 4.

10. The process according to claim 9, wherein the variables in Formulae (B), (D), (F) and (H) have the following meanings:
each R₁₁ is independently a divalent organic group having 2 to 16 carbon atoms;
each R₁₂ is independently a divalent organic group having 2 to 16 carbon atoms;
each R₂ is independently a direct bond or an organic group having 1 to 18 carbon atoms; or two -Q-B-Q-moieties share one B atom and form a spiro ring;
each A is independently a ring having 5 or 6 ring members;
each Q is oxygen; and
n is 2 or 3.

11. The process according to claim 1, wherein the B-containing compound (3) is selected from a compound having a structure of B(QR)₃ and a compound of Formula (B3) 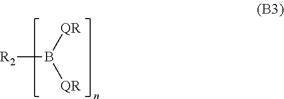
wherein R is selected from H or C₁-C₆-alkyl;
each Q is independently an element of the sixth main group;
each R₂ is independently a direct bond or an organic group having 1 to 20 or 1 to 18 carbon atoms; and
n is 2, 3 or 4.

12. The process according to claim 1, wherein the polyol-type compound (4) is selected from a compound of Formulae (B4), (B4′), (D4), (D4′), (F4), (F4′), (H4) and (H4′): 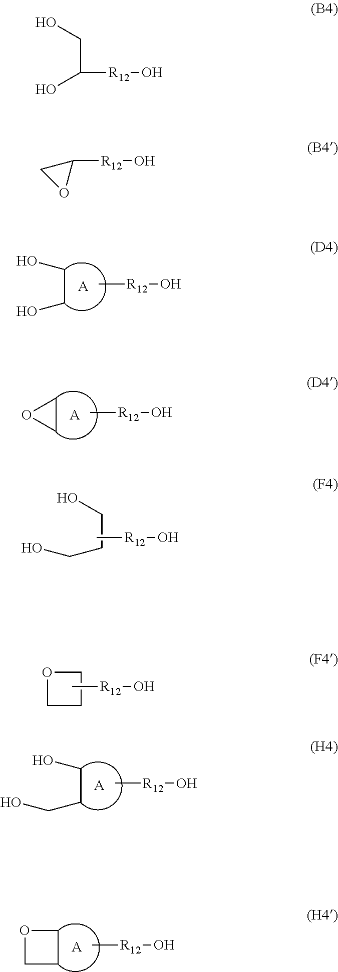
each A is independently a ring having 5 to 10, for example 5 or 6 ring members; and
each R₁₂ is independently a divalent organic group having 1 to 20 or 2 to 16 carbon atoms.

13. The process according to claim 1, wherein the compound (5) containing a carboxyl and a mercapto group (—SH) is compound of Formula (B5) 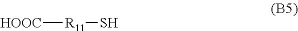
wherein R₁₁ is a divalent organic group having 1 to 20 or 2 to 16 carbon atoms.

14. The process according to claim 9, wherein the compound (1) is a compound of Formula (B) 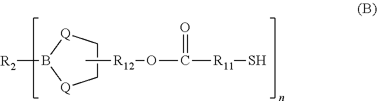
wherein the process comprises reacting a B-containing compound (3) selected from a compound having a structure of B(QR)₃ and a compound of Formula (B3) 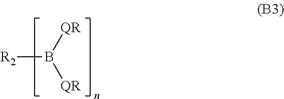
wherein R is selected from H or C₁-C₆-alkyl, and
R₂, Q and n are as defined above,
with a polyol-type compound (4) selected from a compound of Formulae (B4) and (B4′), 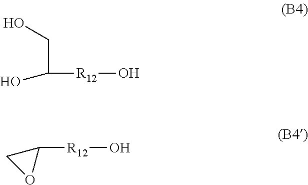
wherein R₁₂ is as defined above,
to obtain a reaction mixture (2), and
reacting the reaction mixture (2) with a compound (5) selected from a compound of Formula (B5) 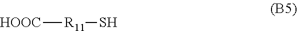
wherein R₁₁ is as defined above,
to obtain a compound of Formula (B).

15. The process according to claim 9, wherein the compound (1) is a compound of Formula (D) 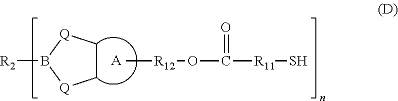
wherein the process comprises reacting a B-containing compound (3) selected from a compound having a structure of B(QR)₃ and a compound of Formula (B3) 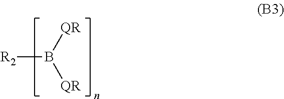
wherein R is selected from H or C₁-C₆-alkyl, and
R₂, Q and n are as defined above,
with a polyol-type compound (4) selected from a compound of Formulae (D4) and (D4′) 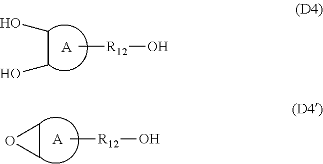
wherein A and R₁₂ are as defined above,
to obtain a reaction mixture (2), and
reacting the reaction mixture (2) with a compound (5) selected from a compound of Formula (B5) 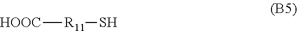
wherein R₁₁ is as defined above,
to obtain a compound of Formula (D).

16. The process according to claim 9, wherein the compound (1) is a compound of Formula (F) 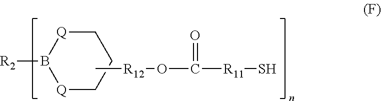
wherein the process comprises reacting a B-containing compound (3) selected from a compound having a structure of B (QR); and a compound of Formula (B3) 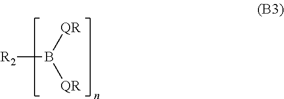
wherein R is selected from H or C₁-C₆-alkyl, and
R₂, Q and n are as defined above,
with a polyol-type compound (4) selected from a compound of Formulae (F4) and (F4′), 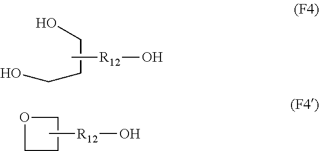
wherein R₁₂ is as defined above,
to obtain a reaction mixture (2), and
reacting the reaction mixture (2) with a compound (5) selected from a compound of Formula (B5) 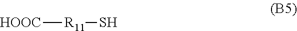
wherein R₁₁ is as defined above,
to obtain a compound of Formula (F).

17. The process according to claim 9, wherein the compound (1) is a compound of Formula (H) 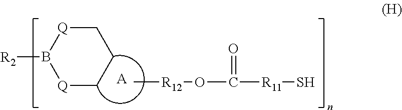
wherein the process comprises reacting a B-containing compound (3) selected from a compound having a structure of B(QR)₃ and a compound of Formula (B3) 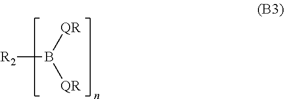
wherein R is selected from H or C₁-C₆-alkyl, and
R₂, Q and n are as defined above,
with a polyol-type compound (4) selected from a compound of Formulae (H4) and (H4′) 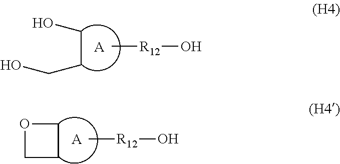
wherein A and R₁₂ are as defined above,
to obtain a reaction mixture (2), and
reacting the reaction mixture (2) with a compound (5) selected from a compound of Formula (B5) 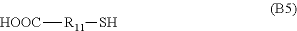
wherein R₁₁ is as defined above,
to obtain a compound of Formula (H).

18. The process according to claim 9, wherein
each R₁₁ is independently a divalent hydrocarbyl having 1 to 20 carbon atoms;
each R₁₂ is independently a divalent hydrocarbyl having 1 to 20 carbon atoms;
each R₂ is independently a direct bond or a hydrocarbyl having 1 to 20 carbon atoms;
wherein the above hydrocarbyl can optionally be interrupted by one or more non adjacent oxygen atoms, and/or one or more non adjacent carbon atoms in the hydrocarbyl can optionally be replaced with —(CO)—O— and/or CO.

19. The process according to claim 1, wherein compound (1) is (1,4-phenylenebis(1,3,2-dioxaborolane-2,4-diyl))bis(butane-4,1-diyl)bis(11-mercaptoundecanoate).

20. Compound (1) containing at least two reversible borate moieties or derivative thereof and at least two mercapto groups (—SH) obtainable by the one-pot process according to claim 1.

21.-26. (canceled)
